(19) United States
(12) Patent Application Publication
(10) Pub. No.: US 2024/0202637 A1
(43) Pub. Date: Jun. 20, 2024

(54) SYSTEMS AND METHODS FOR DETERMINING ENTITIES BASED ON TRADEMARK PORTFOLIO SIMILARITY

(71) Applicant: Camelot UK Bidco Limited, London (UK)

(72) Inventors: Peter Keyngnaert, Deinze (BE); Michael Huang, San Francisco, CA (US); Jestin John, Danville, CA (US); James Haughey, Belfast (GB); Vrishabh Lakhani, Foster City, CA (US); Ann Smet, Stekene (BE); Jan Waerniers, Aalter (BE); Akanksha Mishra, Miami, FL (US); Hassan Malik, Princeton Junction, NJ (US)

(21) Appl. No.: 18/068,825

(22) Filed: Dec. 20, 2022

(51) Int. Cl. G06Q 10/0639; G06Q 30/0204

(52) U.S. Cl. CPC G06Q 10/06393; G06Q 30/0205

(57) ABSTRACT

Systems and methods are described for determining a second entity having a similar trademark portfolio as a first entity. In embodiments, a user submits a request identifying a first entity. A trademark portfolio generator compiles a trademark portfolio of the first entity by accessing a database of trademarks. A trademark portfolio analyzer analyzes the features of the trademark portfolio to form a trademark portfolio profile. A portfolio similarity score calculator determines a trademark portfolio similarity score based by determining the similarity between the trademark portfolio profile of the first entity and trademark portfolio profiles of the second entity. In embodiments, feature vectors related to trademark portfolio profiles of two or more entities are compared to generate portfolio similarity scores. Based on the portfolio similarity scores, a user interface presents the second entity to the user as an entity having a similar trademark portfolio as the first entity.

### BACKGROUND

A trademark serves to indicate the source of goods or services. A trademark may comprise words and/or designs used in connection with the sale of goods or services. When registering a trademark, the registrant provides a classification of the trademark as well as a description of the goods or services represented to the trademark. A registered trademark serves to exclude others from providing similar goods and services using a similar trademark. To exclude others, a trademark owner needs to be aware of the presence of competing entities providing similar goods or services.

Trademark owners monitoring competing entities and their use of trademarks face many challenges. Trademark registrations and laws vary greatly depending on geographical regions and jurisdictions. The number and size of trademark data sources also pose a considerable hurdle to the trademark owner. Moreover, the trademark portfolios of competing entities change over time as new trademarks are registered and unused trademarks are cancelled.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods are described herein for determining similarities between trademark portfolios of different entities. In embodiments, a user submits a request identifying a first entity. A trademark portfolio generator compiles a trademark portfolio of the first entity by accessing a database of trademarks. A trademark portfolio analyzer analyzes the features of the trademark portfolio to form a trademark portfolio profile. A portfolio similarity score calculator determines a trademark portfolio similarity score at least by determining the similarity between the trademark portfolio profile of the first entity and trademark portfolio profiles of the second entity. In some embodiments, a machine learning model is applied to the trademark portfolio profile to generate a trademark portfolio similarity score. Based on the portfolio similarity score, a user interface presents the second entity to the user as an entity having a similar trademark portfolio as the first entity.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present application and, together with the description, further serve to explain the principles of the embodiments and to enable a person skilled in the pertinent art to make and use the embodiments. Dashed portions of the drawings may represent optional steps and/or elements.

FIG. 1 shows a block diagram of an example system for determining similarities between trademark portfolios in accordance with an embodiment.

FIG. 2A shows a block diagram of an example system for determining similarities between trademark portfolios in accordance with an embodiment.

FIG. 2B shows a block diagram of an example system for determining similarities between trademark portfolios in accordance with an embodiment.

FIG. 3 depicts a flowchart of a method for determining similarities between trademark portfolios in accordance with an embodiment.

FIGS. 4A and 4B depict flowcharts of methods for determining trademark portfolios associated with one or more entities in accordance with embodiments.

FIG. 4C depicts a flowchart of a method for determining similarities between trademark portfolios in accordance with an embodiment.

FIGS. 5A and 5B depict flowcharts of methods for monitoring trends in trademark portfolios in accordance with embodiments.

FIG. 6 depicts a flowchart of a method for filtering entities based on filtering criteria in accordance with an embodiment.

FIG. 7 shows an example user interface (UI) element via which a user may query entities having similar trademark portfolio profiles in accordance with an embodiment.

FIG. 8 shows a block diagram of an example computer system in which embodiments may be implemented.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

As used herein, the term “trademark” is intended to encompass any symbol, logo, image, word, or words legally registered, established by use, or asserted as representing a company, product or service. The word “trademark” also encompasses service marks.

As used herein, the term “trademark portfolio,” may simply be a logical grouping or collection of trademarks owned by one or more entities.

As used herein, the term “goods/services” is to be interpreted as equivalent to the term “goods and/or services.”

The example embodiments described herein are provided for illustrative purposes and are not limiting. The examples described herein may be adapted to any type of method or system for obtaining evidence of online commercial use of trademark. Further structural and operational embodiments, including modifications/alterations, will become apparent to persons skilled in the relevant art(s) from the teachings herein.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section may be combined with any other embodiments described in the same section and/or a different section.

### II. Example Embodiments

As discussed in the Background Section above, trademark owners monitoring competing entities and their use of trademarks face many challenges. Trademark registrations and laws vary greatly depending on geographical regions and jurisdictions. The number and size of trademark data sources also pose a considerable hurdle to the trademark owner. Moreover, the trademark portfolios of competing entities change over time as new trademarks are registered and unused trademarks are cancelled.

The embodiments described herein are directed to techniques for determining the similarity between trademark portfolios. For instance, competing entities can be determined based on similarities in characteristics in the trademarks and/or trademark portfolios owned by entities. Some characteristics may include a tally of trademarks owned by the entities in each trademark class or trademark sub-class, the percentage of trademarks owned by the entities in each trademark class or trademark sub-class, the geographical region where the trademark is registered, and the like. Similarities in the goods and services provided by entities may be inferred from the classification information of the trademark. In some embodiments, textual analysis of goods and services descriptions may be used to classify the trademark.

The techniques described herein advantageously enable a user to easily query and monitor trademarks to determine the existence of current and/or future competitors. For instance, a user may input one or more input entities to find other entities that have similar trademark portfolios as the trademarks owned by the input entities. Features may be extracted from the trademarks and/or trademark portfolios owned by the input entities to create a first feature vector. The first feature vector may then be provided to a trademark portfolio similarity score calculator for comparison to other feature vectors corresponding to known second entities. Based on a trademark portfolio similarity score corresponding to each second entity, one or more of the second entities are provided to the user.

In other embodiments, feature extraction may result in a plurality of feature vectors, where each feature vector relates to a particular aspect of the input entities. By way of example, one feature vector may relate to service marks owned by the input entities for services provided by the input entities, while another feature vector may relate to trademarks owned by the input entities for good sold by the input entities. In other embodiments, the plurality of feature vectors may each relate to a different market sector or geographic region of the input entities. Furthermore, in some embodiments the user may assign weights to each of the plurality of feature vectors to designate the relative importance of each feature vector when performing the query. In such an embodiment, the trademark portfolio similarity score calculator will take the user-assigned weights into account when calculating the trademark portfolio score.

By way of example, the trademark portfolio similarity score calculator may calculate a trademark portfolio similarity score by determining the similarity or distance between feature vectors, including, but not limited to, cosine similarity, Euclidean distance, and the like. In some embodiments, the portfolio similarity score calculator may be implemented as a machine learning model. As new trademark information becomes available the machine learning model may be updated or retrained to further improve its accuracy. The machine learning model may also be updated based on feedback from a user. For example, if a user indicates that an entity is not a competitor, the machine learning model may be updated to reflect this feedback.

In addition, a graphical user interface (GUI) may be provided to the user. The GUI may allow a user to search for competitors by entering one or more query entities. As the user enters a query entity, one or more similar entities may be suggested to the user for inclusion in the query. The user may also be provided the option to include trademarks owned by subsidiaries of the query entities in the query. The GUI may also provide the user with filtering options to filter the results based on any number of factors, including but not limited to, a similarity score threshold, a maximum number of results, a geographic region of the entities, a market sector of the entities, and the like. Additionally, the GUI may allow the user to assign weights to each to designate the relative importance of each feature vector when performing the query.

In other embodiments, the user may also subscribe to monitoring alerts. By entering monitoring criteria, a user may be alerted to entities that trigger the monitoring criteria. For example, the monitoring criteria include but are not limited to, one or more of the tallies of trademarks owned by an entity in one or more trademark class or trademark sub-class, a percentage of trademarks owned by an entity in one or more trademark class or trademark sub-class, a similarity score threshold, a geographical region, and the like. For example, as entities register new trademarks in different trademark classes or trademark sub-classes, the portfolio similarity scores between a reference feature vector and other feature vectors of other entities are recalculated. Trends or changes in the trademark similarity scores are monitored over time. When the trends or changes in the trademark similarity scores satisfy a user-defined or predetermined criterion, an alert identifying the triggering entity is generated and provided to the user. Monitoring alerts may inform the user of new entities in the market, entities expanding into new geographical regions or market sectors, candidates for merger or acquisition, and the like.

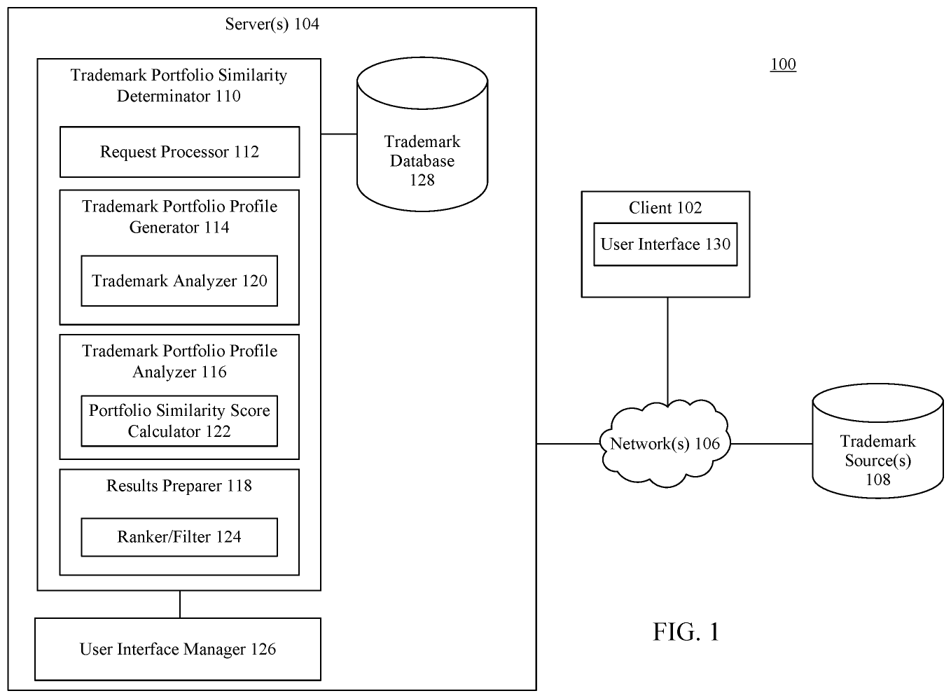

Embodiments may be configured in various ways in various environments. For instance, FIG. 1 shows a block diagram of system 100 for determining the similarities between two or more trademark portfolios. System 100 may include client 102, one or more servers 104, and one or more trademark sources 108 connected by one or more networks 106. Client 102 may interact with the server(s) 104 via user interface (UI) 130 over networks(s) 106. Furthermore, each server 104 includes a trademark portfolio similarity determiner 110, a user interface manager 126, and a trademark database 128. Trademark portfolio similarity determiner 110 includes a request processor 112, a trademark portfolio profile generator 114, a trademark portfolio profile analyzer 116, and a results preparer 118. Trademark portfolio profile generator 114 includes a trademark analyzer 120. Trademark portfolio profile analyzer 116 includes a portfolio similarity store calculator 122. Results preparer 118 includes a ranker/filter 124. Each of the components of system 100 are described in detail as follows.

Client 102 includes any computing device suitable for performing functions that are ascribed thereto in the following description, as will be appreciated by persons skilled in the relevant art(s), including those mentioned elsewhere herein or otherwise known. Various example implementations of client 102 are described below in reference to computing device 802 of FIG. 8. Client 102 is communicatively connected to server(s) 104. Although only a single client 102 is shown in FIG. 1 for the sake of illustration, it is to be understood that system 100 may include any number of clients, each of which is capable of communicating with server(s) 104 to invoke and/or perform functions relating to determining trademark portfolio similarities as will be described herein.

Server(s) 104 is intended to broadly represent any server computing device(s) that is/are suitable for performing functions that are ascribed thereto in the following description, as will be appreciated by persons skilled in the relevant art(s), including those mentioned elsewhere herein or otherwise known. With reference to the exemplary computing environment 800 of FIG. 8 described below, server(s) 104 may be implemented as on-premises servers 892, as part of network-based server infrastructure 870, or both.

Network(s) 106 is intended to broadly represent any network(s) suitable for interconnecting and enabling the communication of data between computing devices. network(s) 106 may comprise one or more networks such as local area networks (LANs), wide area networks (WANs), enterprise networks, the Internet, etc., and may include one or more wired and/or wireless portions.

Trademark source(s) 108 is any database containing trademark information. Trademark source(s) 108 comprise a repository of information about trademarks stored in an organized manner in non-volatile memory across one or more storage components or devices. Trademark source(s) 108 may comprise, for example, a privately managed database of trademark information that includes trademark information compiled from a plurality of trademark registers across a plurality of different geographic regions and/or countries, and periodically updated. Alternatively, trademark source(s) 108 may comprise a publicly available database of trademark information maintained and updated, e.g., by a trademark office associated with a particular country, region or organization. Trademark source(s) 108 may comprise information about registered trademarks, trademarks that are pending registration, and/or trademarks for which registration has lapsed. For a given trademark, trademark source(s) 108 may store information such as but not limited to a trademark country, a trademark name, a trademark image (e.g., design or logo), trademark classes and subclasses, goods/services descriptions for each class, a serial number, a filing date, a registration number, a registration date, owner information, a description of mark, a type of mark, and a status of mark.

In the example implementation depicted in FIG. 1, the application comprises a “front-end” component comprising at least a user interface 130 that executes on client 102, as well as a number of “back-end” components that execute on server(s) 104. Client 102 is communicatively connected to server(s) 104 (e.g., via network(s) 106 or some other network(s) or peer-to-peer connection), such that these components may interact with each other. However, this is only one example implementation. In an alternate implementation, all of the components of the application may execute on a single computing device. In a further alternate implementation, the distribution of components between client 102 and server(s) 104 may be different than that shown in FIG. 1.

User interface 130 executing on client 102 is an interface by which a user interacts with the application. User interface 130 may operate to accept input to the application from a user and to present outputs of the application to the user. User interface 130 may comprise one or more of a graphical UI (GUI), a touchscreen GUI, a menu-driven interface, a command line interface, a voice UI, a conversational UI, or the like, including further or alternative user interface elements mentioned elsewhere herein. In certain embodiments, User interface 130 may be presented to the user via a browser executing on client 102.

As shown in FIG. 1, the “back-end” components of the application implemented on server(s) 104 include trademark portfolio similarity determinator 110, a user interface manager 126, and a trademark database 128.

Trademark database 128 comprises a repository of information about trademarks stored in an organized manner in non-volatile memory across one or more storage components or devices. Trademark database 128 may comprise, for example, a privately managed database of trademark information that includes trademark information compiled from a plurality of trademark registers across a plurality of different geographic regions and/or countries, and periodically updated. Trademark database 128 may comprise information about registered trademarks, trademarks that are pending registration, and/or trademarks for which registration has lapsed. For a given trademark, trademark database 128 may store information such as but not limited to a trademark country, a trademark name, a trademark image (e.g., design or logo), trademark classes and subclasses, goods/services descriptions for each class, a serial number, a filing date, a registration number, a registration date, owner information, a description of mark, a type of mark, and a status of mark.

User interface manager 126 is a component of the application that operates to receive inputs from the user via user interface 130 and to invoke features of the application responsive to those inputs. User interface manager 126 also operates to present outputs of the application to the user via user interface 130.

In response to receiving the request, user interface manager 126 provides the request to trademark portfolio similarity determinator 110 which utilizes information from trademark database 128 and/or trademark source(s) 108 to generate a list of one or more entities that have a similar trademark portfolio profile as the one or more input entities. User interface manager 126 then presents the results generated by trademark portfolio similarity generator 110 to the user via user interface 130.

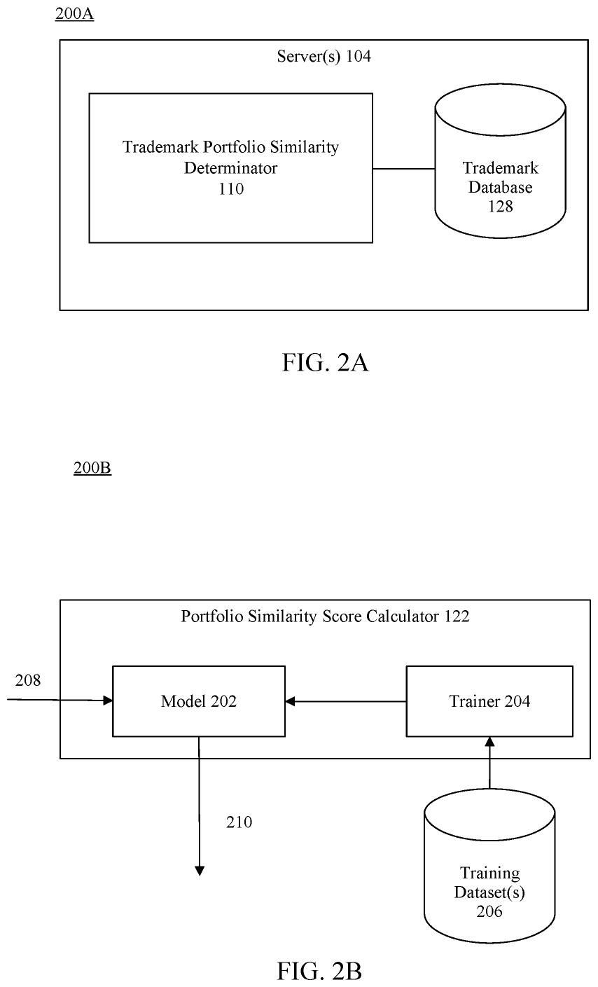

Note that in alternative embodiments, system 100 of FIG. 1 may be configured in alternative ways. For instance, FIGS. 2A and 2B depict block diagrams of a system 200A and a system 200B, each configured for determining the similarities between two or more trademark portfolios. Systems 200A and 200B are described in further detail as follows.

With reference to FIG. 2A, system 200A may include one or more servers 104. Each server 104 includes a trademark portfolio similarity determiner 110, a user interface manager 126, and a trademark database 128. System 200A represents a higher-level embodiment of system 100 depicted in FIG. 1. With reference to FIG. 2B, system 200B represents a system for determining trademark portfolio similarity that utilizes machine learning. In particular, system 200B includes portfolio similarity score calculator 122 of FIG. 1 and one or more training datasets 206. Furthermore, portfolio similarity score calculator 122 includes a model 202 and a trainer 204. Model 202 is a machine learning (ML) model configured to receive a first feature vector representing a first trademark portfolio profile as input. Model 202 classifies the first feature vector into the most likely classes of a plurality of candidate classes to generate output 210. Each of the candidate classes may represent an entity and/or its respective trademark portfolio. Output 210 may represent a combination of portfolio similarity score(s) and corresponding entity identifier(s) of the most likely classes.

In some embodiments, model 202 is generated based on a supervised machine learning algorithm using one or more training datasets 206. Training dataset(s) 206 may include a subset of data that are used by trainer 204 to train a model and subset of data to test the trained model. In some embodiments, training dataset(s) 206 may include some or all the data of trademark source(s) 108 and trademark database 128. Trainer 204 may extract features related to each trademark portfolio in the training data to generate second feature vector(s) for classifying a new feature vector. Trainer 204 may test the trained model using a test dataset.

Model 202 may classify a first feature vector by calculating the distance between a first feature vector and second feature vector(s) to predict the entities corresponding to the second feature vector(s) that most resemble the first feature vector. Model 202 may output the identifiers of the entities corresponding to the second feature vector(s) that most resemble the first feature vector and a confidence score. In some embodiments, the portfolio similarity score may be based on the confidence score. Model 202 may be based on any known classification model algorithm, such as but not limited to neural networks, Naive Bayes, k-nearest neighbor, support vector machines, and the like.

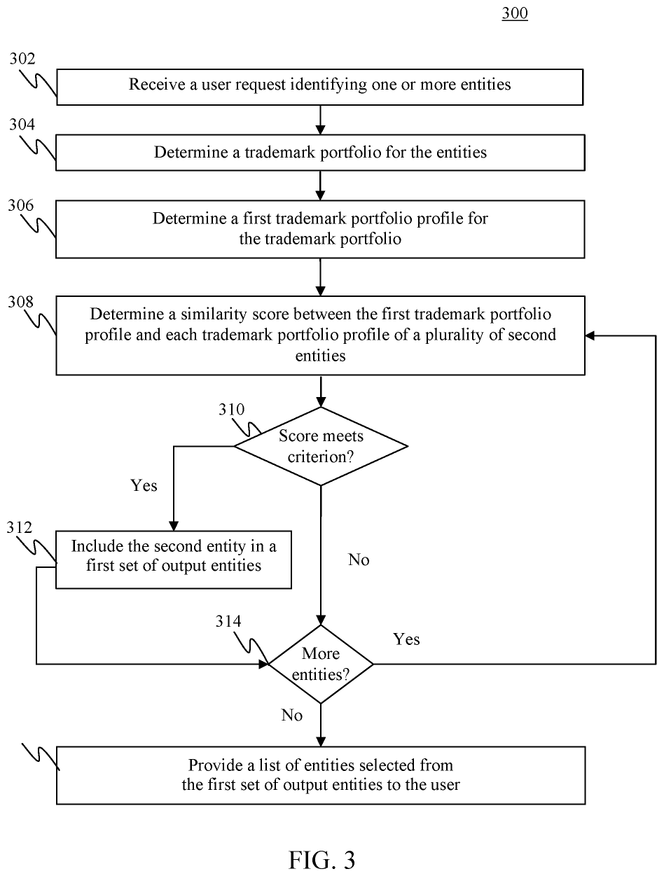

System 100 of FIG. 1 may operate in various ways, including as described above and in further ways. For instance, FIG. 3 depicts a flowchart 300 of a method for determining similarities between trademark portfolios in accordance with an embodiment. In an embodiment, flowchart 300 may be implemented by system 100. Accordingly, flowchart 300 will be described with continued reference to FIG. 1. Other structural and operational embodiments will be apparent to persons skilled in the relevant art(s) based on the following discussion regarding flowchart 300 and system 100.

As shown in FIG. 3, the method of flowchart 300 starts at step 302, where a user request identifying one or more entities is received. For example, user interface manager 126 may receive from a user via user interface 130, a search request for competing entities having a similar profile as one or more input entities. The user may identify the input entities in the request. The request is provided to trademark portfolio similarity determinator 110 and is processed by request processor 112.

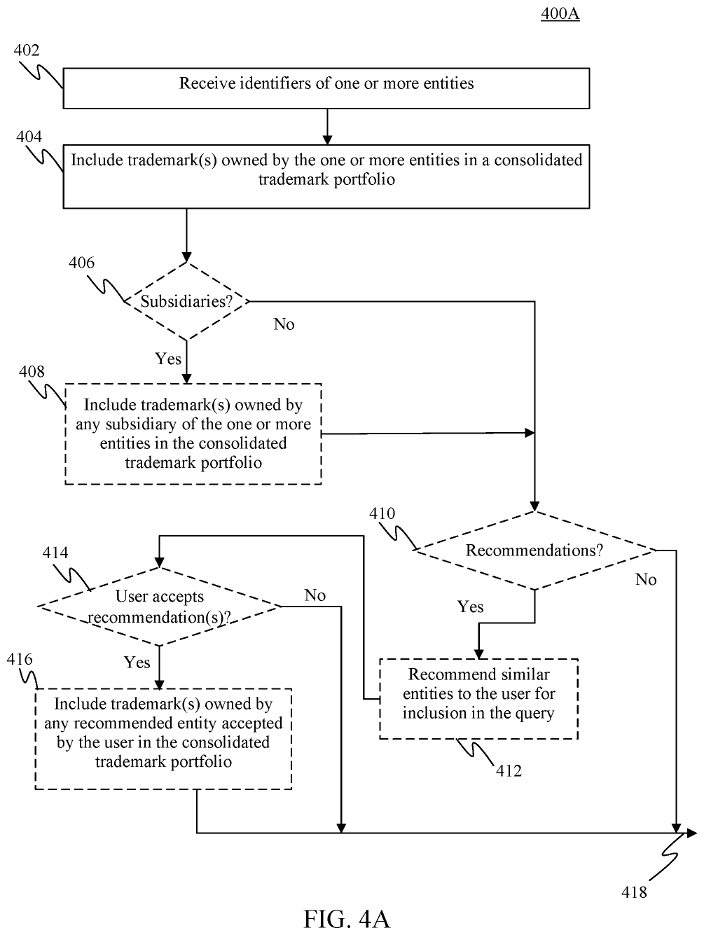

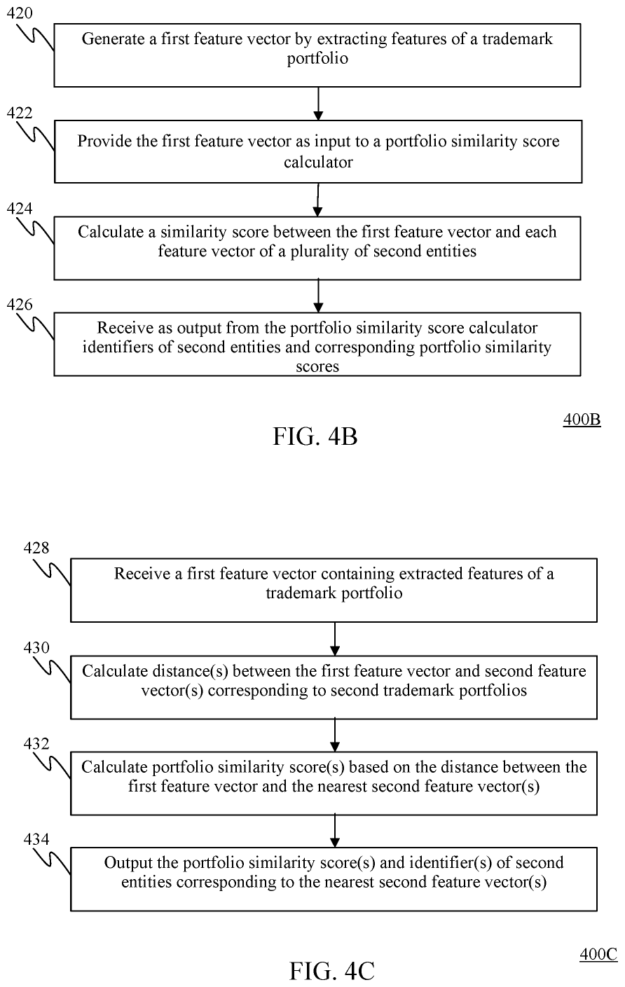

At step 304, a trademark portfolio is determined for the input entities. For example, trademark portfolio similarity determinator 110 may access trademark database 128 and/or trademark source(s) 108 to retrieve trademark information related to the input entities and provide the trademark information to trademark portfolio profile generator 114. In an embodiment that will be discussed below with respect to FIG. 4A, a trademark portfolio may include trademarks related to subsidiaries of the input entities and trademarks related to companies suggested by server(s) 104.

At step 306, a trademark portfolio profile is determined for the trademark portfolio of the input entities. For example, trademark portfolio profile generator 114 may receive the trademark portfolio and extract one or more features or characteristics of the trademarks of the trademark portfolio. The features or characteristics of the trademarks may include information such as but not limited to a trademark country, a trademark name, a trademark image (e.g., design or logo), trademark classes and subclasses, goods/services descriptions for each class, a serial number, a filing date, a registration number, a registration date, owner information, a description of mark, a type of mark, and a status of mark. Furthermore, trademark analyzer 120 may perform textual and/or graphical analysis of the trademark name, the trademark image (e.g., design or logo), the goods/services and/or the description of mark to infer a trademark class or subclass of the mark. The first trademark portfolio profile may also include features or characteristics of the trademark portfolio such as but not limited to the tally or percentage of trademarks within a particular trademark class, trademark subclass, and/or trademark country. As will be discussed below with respect to FIG. 4B, the trademark portfolio profile generator 114 may generate a first feature vector representing the features or characteristics of the trademark portfolio.

At step 308, a similarity score is determined between the first trademark portfolio and each trademark portfolio profile of a plurality of second entities. For example, trademark portfolio profile generator 114 may pass the first trademark portfolio profile as input to portfolio similarity store calculator 122 to generate a trademark portfolio similarity score between the first trademark portfolio and a second trademark portfolio profile representing the trademark portfolio of the second entity. Step 308 may be repeated for each of a plurality of second entities to determine a plurality of similarity scores.

At step 310, it is determined whether the score meets the criterion. For example, trademark portfolio profile analyzer 116 compares the trademark portfolio similarity score to a predetermined, a dynamic and/or a user-defined criterion. If the trademark portfolio similarity score satisfies the criterion, method 300 proceeds to step 312. If the trademark portfolio similarity score does not satisfy the criterion, method 300 proceeds to step 314.

At step 312, the second entity is included in a first set of output entities. For example, results preparer 118 may include the second entity may be included in a set of output entities based on the trademark portfolio similarity score meeting the criterion.

At step 314, it is determined whether more entities are under consideration. For example, trademark portfolio profile analyzer 116 determines whether additional second entities are under consideration. If more second entities are under consideration, method 300 returns to step 308, where steps 308, 310 and/or 312 may be repeated for additional second entity. If no more second entities are under consideration, method 300 proceeds to step 316.

At step 316, a list of entities selected from the first set of output entities is provided to the user. For example, ranker/filter 124 may determine the second entities with the highest similarity scores that meet the criterion. The list of entities may be provided to results preparer 118 for formatting in a proper format for output to the user, and then provided to user interface manager 126 for output to the user via user interface 130.

FIG. 4A depicts a flowchart 400A of a method for determining similarities between trademark portfolios in accordance with an embodiment. The method of flowchart 400A may represent sub-steps related to step 304 of FIG. 3. In an embodiment, flowchart 400A may be implemented by system 100. Accordingly, flowchart 400A will be described with continued reference to FIG. 1. Other structural and operational embodiments will be apparent to persons skilled in the relevant art(s) based on the following discussion regarding flowchart 400A and system 100.

At step 402, identifiers of one or more input entities are received. For example, user interface manager 126 may receive from a user via user interface 130, a search request for competing entities having a similar profile as one or more input entities.

At step 404, the trademarks owned by the one or more input entities are included in a consolidated trademark portfolio. For example, trademark portfolio similarity determinator 110 may access trademark database 128 and/or trademark source(s) 108 to retrieve trademark information related to the input entities and provide the trademark information to trademark portfolio profile generator 114 for inclusion in the consolidated trademark portfolio.

At optional step 406, it is determined whether subsidiaries exist for the input entities. For example, trademark portfolio profile generator 114 may access one or more databases containing corporate ownership data to determine whether any subsidiaries exist for the input entities. In some embodiments, trademark portfolio similarity determinator 110 may prompt the user for input to determine whether trademarks owned by the subsidiaries should be included in the consolidated trademark portfolio.

At optional step 408, one or more trademarks owned by any subsidiary of the one or more entities is included in the consolidated trademark portfolio. For example, if subsidiaries exist and if the user opts to include the subsidiaries in the query, trademark portfolio profile generator 114 may include the trademarks owned by the subsidiaries in the consolidated trademark portfolio.

At optional step 410, the method determines whether additional entities should be recommended to the user. For example, trademark portfolio profile generator 114 may suggest entities to the user for inclusion in the query. In one embodiment, the additional entities may be provided as part of an auto-complete feature while the user inputs text into a text field of user interface 130.

At optional step 412, similar entities are recommended to the user for inclusion in the query. For example, user interface manager 126 may provide the suggested entities to the user via user interface 130.

At optional step 414, whether the user accepts the recommendation is determined. For example, trademark portfolio profile generator 114 may determine whether the user accepts the recommended entities. For example, the user may click on one or more user-selectable elements of user interface 130 representing an additional entity to include the additional entity in the query.

At optional step 416, the trademark(s) owned by any recommended entity accepted by the user is/are included in the consolidated trademark portfolio. For example, trademark portfolio profile generator 114 includes the trademarks owned by any recommended entity accepted by the user in the consolidated trademark portfolio.

At step 418, the method 400A proceeds to method 400B of FIG. 4B where the consolidated trademark portfolio is analyzed to generate a trademark portfolio profile.

FIG. 4B depicts a flowchart 400B of a method for determining similarities between trademark portfolios in accordance with an embodiment. The method of flowchart 400B may represent sub-steps related to steps 306 and 308 of FIG. 3. In an embodiment, flowchart 400B may be implemented by system 100. Accordingly, flowchart 400B will be described with continued reference to FIG. 1. Other structural and operational embodiments will be apparent to persons skilled in the relevant art(s) based on the following discussion regarding flowchart 400B and system 100.

At step 420, features are extracted from the trademark portfolio to generate a first feature vector. For example, trademark portfolio profile analyzer 116 may analyze the trademark portfolio to generate the first feature vector. The features or characteristics of the trademarks may include information such as but not limited to a trademark country, a trademark name, a trademark image (e.g., design or logo), trademark classes and subclasses, goods/services descriptions for each class, a serial number, a filing date, a registration number, a registration date, owner information, a description of mark, a type of mark, and a status of mark. Furthermore, trademark analyzer 120 may perform textual and/or graphical analysis of the trademark name, the trademark image (e.g., design or logo), the goods/services and/or the description of mark to infer a trademark class or subclass of the mark. The consolidated trademark portfolio profile may also include features or characteristics of the trademark portfolio such as but not limited to the tally or percentage of trademarks within a particular trademark class, trademark subclass, and/or trademark country.

At step 422, the feature vector is provided to a portfolio similarity store calculator. At step 424, the similarity between the first feature vector and a second feature vector representing the trademark portfolio profile of a second entity is calculated. By way of example, portfolio similarity store calculator 122 may calculate a trademark portfolio similarity score by determining the similarity or distance between feature vectors. The similarity or distance may be determined using one or more techniques, including but not limited to, cosine similarity, Euclidean distance, and the like. In some embodiments, portfolio similarity store calculator 122 may be implemented as a machine learning model. As new trademark information becomes available the machine learning model may be updated or retrained to further improve its accuracy. The machine learning model may also be updated based on feedback from a user. For example, if a user indicates that an entity is not a competitor, the machine learning model may be updated to reflect this feedback. The user feedback may be used to update a user-specific machine learning model and/or a global machine learning model.

At step 426, identifiers of second entities and their corresponding portfolio similarity scores are received as output from the portfolio similarity score calculator. For example, portfolio similarity store calculator 122 provides the trademark portfolio similarity score and/or a corresponding identifier of the second entity. For example, portfolio similarity score calculator may provide the trademark portfolio similarity score and/or a corresponding identifier of the second entity to results preparer 118 for ranking, filtering, and/or output to the user via user interface 130.

FIG. 4C depicts a flowchart 400B of a method for determining similarities between trademark portfolios in accordance with an embodiment. The method of flowchart 400C may represent sub-steps related to step 424 of FIG. 4B. In an embodiment, flowchart 400C may be implemented by portfolio similarity score calculator 122 of systems 100 and/or 200B. Accordingly, flowchart 400B will be described with continued reference to FIG. 1 and FIG. 2B. Other structural and operational embodiments will be apparent to persons skilled in the relevant art(s) based on the following discussion regarding flowchart 400C and systems 100 and 200B.

At step 428, a first feature vector containing extracted features of a trademark portfolio is received. For example, portfolio similarity score calculator 122 receives a first feature vector generated by extracting features of a first trademark portfolio. For example, portfolio similarity score calculator 122 may input the first feature vector 208 into model 202.

At step 430, a distance between the first feature vector and second feature vector(s) corresponding to second trademark portfolios is/are calculated. For example, model 202 may calculate the distance between the first feature vector and second feature vector(s) corresponding to second trademark portfolio profiles associated with second entities. Based on the calculated distances between the first feature vector and second feature vector(s), model 202 may determine the nearest second feature vector(s) corresponding to the trademark portfolios that most resemble the consolidated trademark portfolio.

At step 432, portfolio similarity score(s) are calculated based on the distance between the first feature vector and the nearest second feature vector(s). For example, model 202 may calculate portfolio similarity score(s) for each of the nearest second feature vector(s). In some embodiments, the portfolio similarity score(s) may be a confidence score that is based on the distance between the first feature vector and each of the nearest second feature vector(s).

At step 434, portfolio similarity score(s) and identifier(s) of second entities corresponding to the nearest second feature vector(s) are returned as output. For example, model 202 may output the identifier of the entities corresponding to each of the nearest second feature vector(s) along with their corresponding portfolio similarity score(s).

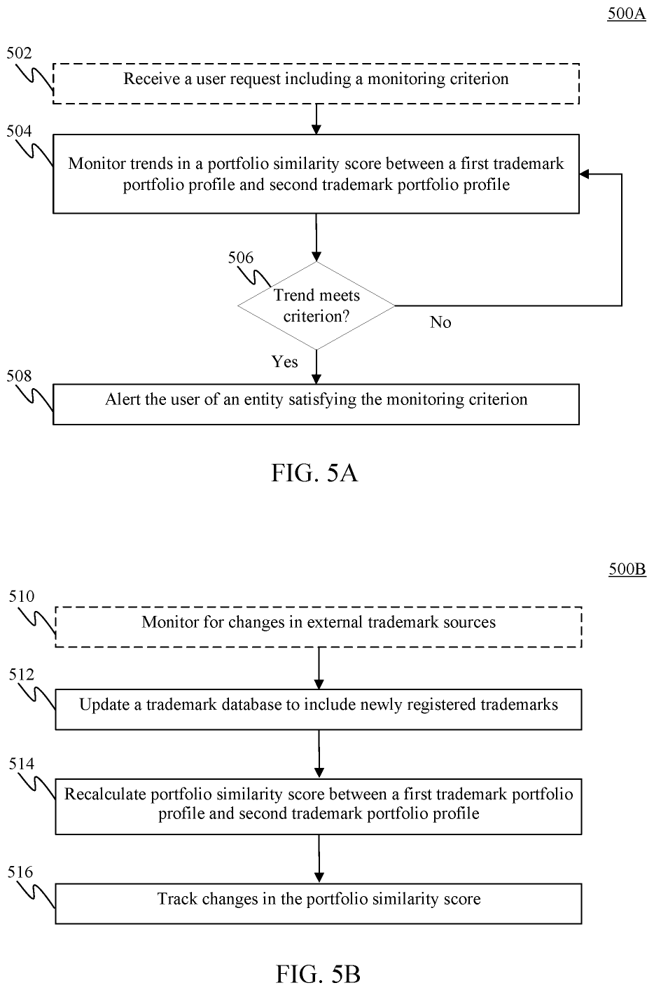

FIG. 5A depicts a flowchart 500A of a method for monitoring similarities between trademark portfolios in accordance with an embodiment. The method of flowchart 500A may represent an optional feature that allows a user to monitor entities according to a monitoring criterion. In an embodiment, flowchart 500A may be implemented by system 100. Accordingly, flowchart 500A will be described with continued reference to FIG. 1. Other structural and operational embodiments will be apparent to persons skilled in the relevant art(s) based on the following discussion regarding flowchart 500A and system 100.

At optional step 502, a user monitoring request including a monitoring criterion is received. For example, a user may input via user interface 130 a monitoring criterion that, when satisfied, will trigger the transmission of a notification identifying one or more entities that newly satisfy the monitoring criterion. Alternatively, step 502 may be optional and trademark portfolio similarity determinator 110 may employ the user's original query as the monitoring criterion.

At step 504, trends in a trademark portfolio similarity score between a first trademark portfolio profile and second trademark portfolio profile are monitored. In some embodiments, step 504 may include monitoring a plurality of trademark portfolio similarity scores indicating the similarity between a first trademark portfolio profile for a first entity and a plurality of second trademark portfolio profiles corresponding to a plurality of second entities. As will be discussed below with respect to FIG. 5B, the trademark portfolio profile generator 114 may recalculate and track the trademark portfolio similarity score to determine trends in the trademark portfolio similarity score.

At step 506, the method determines whether the trend(s) meets the monitoring criterion. For example, trademark portfolio similarity determinator 110 may determine whether the trends in the trademark portfolio similarity score satisfies the monitoring criterion. For example, the monitoring criterion may be satisfied when the trademark similarity score satisfies a threshold, or the like. If the monitoring criterion is satisfied, method 500 proceeds to step 508. If the monitoring criterion is not satisfied, the method 500 returns to step 504 where the method continues monitoring trends in the trademark portfolio similarity score(s). In embodiments, the monitoring may be performed continuously, in real-time, periodically and/or according to any other timing scheme.

At step 508, a user is alerted of the second entity satisfying the monitoring criterion. For example, results preparer 118 may generate a notification including an identifier of a second entity that newly satisfies the monitoring criterion. The notification may be provided to user interface manager 126 and displayed to the user via user interface 130. Alternatively, the notification may be transmitted through an external channel such as but not limited to electronic mail (e-mail), short messaging service (SMS), push notification, or the like.

FIG. 5B depicts a flowchart 500B of a method for monitoring similarities between trademark portfolios in accordance with an embodiment. The method of flowchart 500B may represent sub-steps related to step 504 of FIG. 5A. In an embodiment, flowchart 500B may be implemented by system 100. Accordingly, flowchart 500B will be described with continued reference to FIG. 1. Other structural and operational embodiments will be apparent to persons skilled in the relevant art(s) based on the following discussion regarding flowchart 500B and system 100.

At optional step 510, changes in external trademark source(s) are monitored. For example, trademark portfolio similarity determinator 110 may monitor trademark source(s) 108 for newly registered, updated and/or canceled trademarks. Alternatively, FIG. 5B may update trademark database 128 without actively monitoring trademark source(s) 108. For example, trademark portfolio similarity determinator 110 may subscribe to notifications of any updates, including but not limited to, newly registered, updated and/or canceled trademarks.

At step 512, a trademark database is updated to include any changes detected in the external trademark sources. For example, trademark portfolio similarity determinator 110 may update trademark database 128 based on any detected changes in trademark source(s) 108.

At step 514, a trademark portfolio similarity score indicating the similarity between a first trademark portfolio profile and a second trademark portfolio profile is recalculated. For example, portfolio similarity score calculator 122 may recalculate a trademark portfolio similarity score indicating the similarity between a first trademark portfolio profile for a first entity and a second trademark portfolio profile corresponding to a second entity when changes are detected in the trademark portfolio of the first entity and/or the second entity.

At step 516, changes in the trademark portfolio similarity score(s) are tracked. For example, trademark portfolio similarity determinator 110 may maintain a record of at least a portion of the historical trademark portfolio similarity score(s) over time. Trademark portfolio similarity determinator 110 may use the maintained record to determine trends in the trademark portfolio similarity score(s).

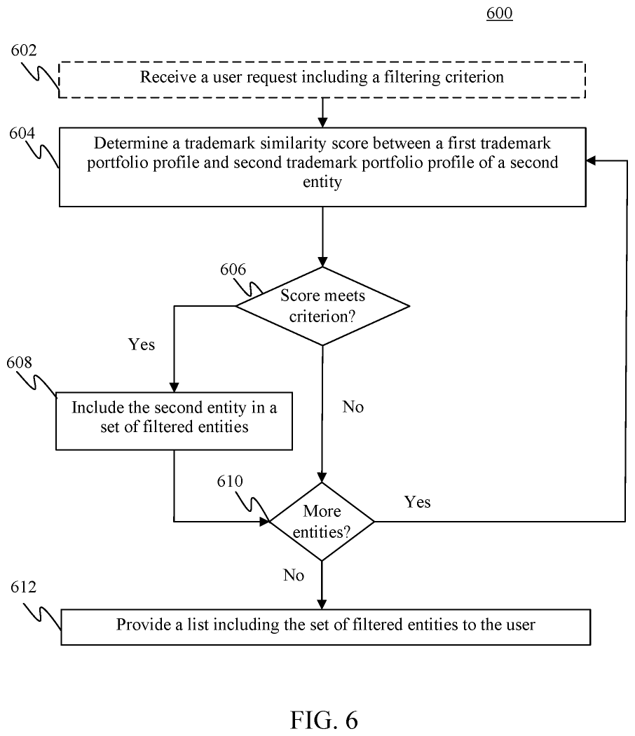

FIG. 6 depicts a flowchart 600 of a method for filtering results in accordance with an embodiment. The method of flowchart 600 may represent an optional feature that allows a user to filter results provided by trademark portfolio similarity determinator 110. In an embodiment, flowchart 600 may be implemented by system 100. Accordingly, flowchart 600 will be described with continued reference to FIG. 1. Other structural and operational embodiments will be apparent to persons skilled in the relevant art(s) based on the following discussion regarding flowchart 600 and system 100.

At optional step 602, a user request including a filtering criterion is received. For example, a user may input via user interface 130 one or more filtering criterion to limit the results provided by trademark portfolio similarity determinator 110. Alternatively, trademark portfolio similarity determinator 110 may filter results based on a default filtering criterion. For example, the default filtering criterion may be maintained as a user preference that may be changed by the user.

At step 604, a trademark similarity score between a first trademark portfolio profile and second trademark portfolio of a second entity is determined. For example, portfolio similarity score calculator 122 may determine a trademark portfolio similarity score indicating the similarity between a first trademark portfolio profile for a first entity and a second trademark portfolio profile corresponding to a second entity is determined. Step 604 may correspond to step 308 of FIG. 3 and/or method 400B of FIG. 4B. Step 604 may represent a first instance of calculating the trademark portfolio similarity score. Alternatively, step 604 may merely represent accessing a previously calculated trademark portfolio similarity score.

At step 606, whether the trademark portfolio similarity score satisfies the filtering criterion is determined. For example, trademark portfolio profile analyzer 116 may compare a newly calculated or a previously calculated trademark portfolio similarity score to the filtering criterion. If the trademark portfolio similarity score satisfies the filtering criterion method 600 proceeds to step 608. If the trademark portfolio similarity score does not satisfy the filtering criterion, method 600 proceeds to step 610.

At step 608, the second entity is included in a set of filtered entities. For example, results preparer 118 may include the second entity in a set of filtered entities based on the trademark portfolio similarity score satisfying the filtering criterion.

At step 610, whether more entities are under consideration is determined. trademark portfolio profile analyzer 116 may determine whether additional entities are under consideration. If more entities are under consideration, method 600 returns to step 604 where steps 604, 606 and/or 608 are repeated for each additional entity under consideration. If no more entities are under consideration, method 600 proceeds to step 612, where a list including the set of filtered entities is returned to the user. For example, trademark portfolio similarity determinator 110 may provide a newly generated list of entities to the user via user interface 130. Alternatively, an existing list of entities currently displayed to the user in user interface 130 may be updated to reflect any changes in the filtering criterion.

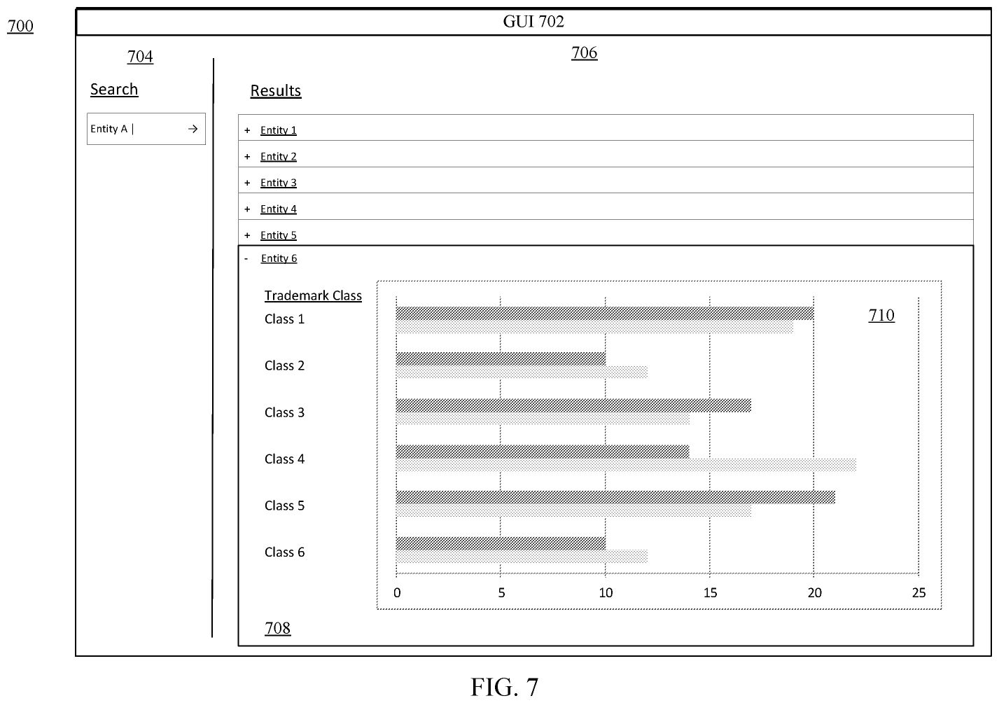

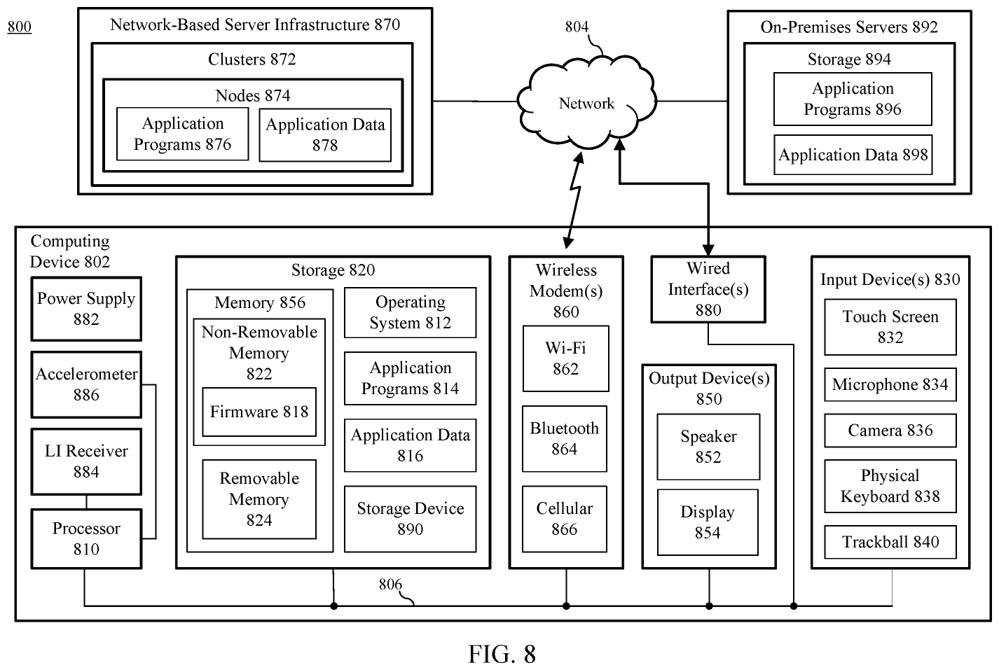

FIG. 7 depicts a graphical user interface (GUI) 700 for determining similarities between trademark portfolios in accordance with an embodiment. In an embodiment, GUI 700 may be implemented by system 100. Accordingly, GUI 700 will be described with continued reference to FIG. 1. Other structural and operational embodiments will be apparent to persons skilled in the relevant art(s) based on the following discussion regarding GUI 700 and system 100.

As shown in FIG. 7, GUI 700 may represent an example of user interface 130. GUI 700 may include one or more window(s) 702. Window 702 may include a search section 704 and a results section 706. Search section 704 includes one or more text input field for entering one or more entities and/or one or more filtering or monitoring criterion. Results section 706 may include zero or more entities satisfying the user's entered query. For example, Entity 1 through Entity 6 may represent entities that have corresponding trademark portfolio similarity scores that satisfy a predetermined or user-defined criterion. Additionally, a user may interact with the results in results section 706 to expand and/or collapse the results to show a detailed results section 708. For example, when the user expands the result representing Entity 6, detailed results section 708 may appear. Detailed results section 708 may display a comparison 710 of a tally and/or percentage of trademarks owned by Entity A and Entity 6 in each trademark class and/or trademark subclass. In embodiments, more than one result may be expanded at the same time. Additionally, the user may further interact with one or more elements of window 702 to increase or decrease the amount of information about the entities (e.g., Entity A, Entity 1, etc.) that is displayed to the user. The elements of GUI 700 depicted in FIG. 7 are merely exemplary, and more or less elements may be included or excluded from GUI 700.

### III. Example Mobile Device and Computer System Implementation

The systems and methods described above in reference to FIGS. 1-7, including client 102, server(s) 104, network(s) 106, trademark source(s) 108, trademark portfolio similarity determinator 110, request processor 112, trademark portfolio profile generator 114, trademark portfolio profile analyzer 116, results preparer 118, trademark analyzer 120, portfolio similarity score calculator 122, ranker/filter 124, user interface manager 126, trademark database 128, user interface 130, each of the components described therein, and/or the steps of flowcharts 300, 400A, 400B, 500A, 500B, and/or 600, and/or GUI 700 may be implemented in hardware, or hardware combined with one or both of software and/or firmware. For example, client 102, server(s) 104, network(s) 106, trademark source(s) 108, trademark portfolio similarity determinator 110, request processor 112, trademark portfolio profile generator 114, trademark portfolio profile analyzer 116, results preparer 118, trademark analyzer 120, portfolio similarity score calculator 122, ranker/filter 124, user interface manager 126, trademark database 128, user interface 130, and/or each of the components described therein, the steps of flowcharts 300, 400A, 400B, 500A, 500B, and/or 600, and/or GUI 700 may be each implemented as computer program code/instructions configured to be executed in one or more processors and stored in a computer readable storage medium. Alternatively, client 102, server(s) 104, network(s) 106, trademark source(s) 108, trademark portfolio similarity determinator 110, request processor 112, trademark portfolio profile generator 114, trademark portfolio profile analyzer 116, results preparer 118, trademark analyzer 120, portfolio similarity score calculator 122, ranker/filter 124, user interface manager 126, trademark database 128, user interface 130, and/or each of the components described therein, the steps of flowcharts 300, 400A, 400B, 500A, 500B, and/or 600, and/or GUI 700 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 8. FIG. 8 shows a block diagram of an exemplary computing environment 800 that includes a computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc., and may include one or more wired and/or wireless portions. Network 804 may additionally or alternatively include a cellular network for cellular communications. Computing device 802 is described in detail as follows

Computing device 802 can be any of a variety of types of computing devices. For example, computing device 802 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 802 may alternatively be a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 890. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and any combination of the components may be present in a particular embodiment. These components of computing device 802 are described as follows.

A single processor 810 (e.g., central processing unit (CPU), microcontroller, a microprocessor, signal processor, ASIC (application specific integrated circuit), and/or other physical hardware processor circuit) or multiple processors 810 may be present in computing device 802 for performing such tasks as program execution, signal coding, data processing, input/output processing, power control, and/or other functions. Processor 810 may be a single-core or multi-core processor, and each processor core may be single-threaded or multithreaded (to provide multiple threads of execution concurrently). Processor 810 is configured to execute program code stored in a computer readable medium, such as program code of operating system 812 and application programs 814 stored in storage 820. Operating system 812 controls the allocation and usage of the components of computing device 802 and provides support for one or more application programs 814 (also referred to as “applications” or “apps”). Application programs 814 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 802 can communicate with any other component according to function, although not all connections are shown for ease of illustration. For instance, as shown in FIG. 8, bus 806 is a multiple signal line communication medium (e.g., conductive traces in silicon, metal traces along a motherboard, wires, etc.) that may be present to communicatively couple processor 810 to various other components of computing device 802, although in other embodiments, an alternative bus, further buses, and/or one or more individual signal lines may be present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 890, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 822 may include main memory and may be separate from or fabricated in a same integrated circuit as processor 810. As shown in FIG. 8, non-removable memory 822 stores firmware 818, which may be present to provide low-level control of hardware. Examples of firmware 818 include BIOS (Basic Input/Output System, such as on personal computers) and boot firmware (e.g., on smart phones). Removable memory 824 may be inserted into a receptacle of or otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 890 may be present that are internal and/or external to a housing of computing device 802 and may or may not be removable. Examples of storage device 890 include a hard disk drive, a SSD, a thumb drive (e.g., a USB (Universal Serial Bus) flash drive), or other physical storage device.

One or more programs may be stored in storage 820. Such programs include operating system 812, one or more application programs 814, and other program modules and program data. Examples of such application programs may include, for example, computer program logic (e.g., computer program code/instructions) for implementing one or more of client 102, server(s) 104, network(s) 106, trademark source(s) 108, trademark portfolio similarity determinator 110, request processor 112, trademark portfolio profile generator 114, trademark portfolio profile analyzer 116, results preparer 118, trademark analyzer 120, portfolio similarity score calculator 122, ranker/filter 124, user interface manager 126, trademark database 128, user interface 130, and/or each of the components described therein, along with any components and/or subcomponents thereof, as well as the flowcharts/flow diagrams (e.g., flowcharts 300, 400A, 400B, 500A, 500B, and/or 600) described herein, including portions thereof, and/or further examples described herein.

Storage 820 also stores data used and/or generated by operating system 812 and application programs 814 as application data 816. Examples of application data 816 include web pages, text, images, tables, sound files, video data, and other data, which may also be sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 802 through one or more input devices 830 and may receive information from computing device 802 through one or more output devices 850. Input device(s) 830 may include one or more of touch screen 832, microphone 834, camera 836, physical keyboard 838 and/or trackball 840 and output device(s) 850 may include one or more of speaker 852 and display 854. Each of input device(s) 830 and output device(s) 850 may be integral to computing device 802 (e.g., built into a housing of computing device 802) or external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 may display information, as well as operating as touch screen 832 by receiving user commands and/or other information (e.g., by touch, finger gestures, virtual keyboard, etc.) as a user interface. Any number of each type of input device(s) 830 and output device(s) 850 may be present, including multiple microphones 834, multiple cameras 836, multiple speakers 852, and/or multiple displays 854.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). Wireless modem 860 may also or alternatively include other radio-based modem types, such as a Bluetooth modem 864 (also referred to as a “Bluetooth device”) and/or Wi-Fi 862 modem (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and may receive power from a battery internal to computing device 802, and/or from a power cord plugged into a power port of computing device 802 (e.g., a USB port, an A/C power port). LI receiver 884 may be used for location determination of computing device 802 and may include a satellite navigation receiver such as a Global Positioning System (GPS) receiver or may include other type of location determiner configured to determine location of computing device 802 based on received information (e.g., using cell tower triangulation, etc.). Accelerometer 886 may be present to determine an orientation of computing device 802.

Note that the illustrated components of computing device 802 are not required or all-inclusive, and fewer or greater numbers of components may be present as would be recognized by one skilled in the art. For example, computing device 802 may also include one or more of a gyroscope, barometer, proximity sensor, ambient light sensor, digital compass, etc. Processor 810 and memory 856 may be co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein may be stored in storage 820 and executed by processor 810.

In some embodiments, server infrastructure 870 may be present in computing environment 800 and may be communicatively coupled with computing device 802 via network 804. Server infrastructure 870, when present, may be a network-accessible server set (e.g., a cloud-based environment or platform). As shown in FIG. 8, server infrastructure 870 includes clusters 872. Each of clusters 872 may comprise a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. Any of nodes 874 may be a storage node that comprises a plurality of physical storage disks, SSDs, and/or other physical storage devices that are accessible via network 804 and are configured to store data associated with the applications and services managed by nodes 874. For example, as shown in FIG. 8, nodes 874 may store application data 878.

Each of nodes 874 may, as a compute node, comprise one or more server computers, server systems, and/or computing devices. For instance, a node 874 may include one or more of the components of computing device 802 disclosed herein. Each of nodes 874 may be configured to execute one or more software applications (or “applications”) and/or services and/or manage hardware resources (e.g., processors, memory, etc.), which may be utilized by users (e.g., customers) of the network-accessible server set. For example, as shown in FIG. 8, nodes 874 may operate application programs 876. In an implementation, a node of nodes 874 may operate or comprise one or more virtual machines, with each virtual machine emulating a system architecture (e.g., an operating system), in an isolated manner, upon which applications such as application programs 876 may be executed.

In an embodiment, one or more of clusters 872 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 872 may be a datacenter in a distributed collection of datacenters. In embodiments, exemplary computing environment 800 comprises part of a cloud-based platform such as Amazon Web Services® of Amazon Web Services, Inc. or Google Cloud Platform™ of Google LLC, although these are only examples and are not intended to be limiting.

In an embodiment, computing device 802 may access application programs 876 for execution in any manner, such as by a client application and/or a browser at computing device 802. Example browsers include Microsoft Edge® by Microsoft Corp. of Redmond. Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 802 may additionally and/or alternatively synchronize copies of application programs 814 and/or application data 816 to be stored at network-based server infrastructure 870 as application programs 876 and/or application data 878. For instance, operating system 812 and/or application programs 814 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 820 at network-based server infrastructure 870.

In some embodiments, on-premises servers 892 may be present in computing environment 800 and may be communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 may be shared by on-premises servers 892 between computing devices of the organization, including computing device 802 (when part of an organization) through a local network of the organization, and/or through further networks accessible to the organization (including the Internet). Furthermore, on-premises servers 892 may serve applications such as application programs 896 to the computing devices of the organization, including computing device 802. Accordingly, on-premises servers 892 may include storage 894 (which includes one or more physical storage devices such as storage disks and/or SSDs) for storage of application programs 896 and application data 898 and may include one or more processors for execution of application programs 896. Still further, computing device 802 may be configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 may be used to implement systems, clients, or devices, or components/subcomponents thereof, disclosed elsewhere herein. In other embodiments, a combination of computing device 802, network-based server infrastructure 870, and/or on-premises servers 892 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 814) may be stored in storage 820. Such computer programs may also be received via wired interface(s) 880 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Conclusion

While various embodiments have been described above, it should be understood that they have been presented by way of example only, and not limitation. It will be understood by those skilled in the relevant art(s) that various changes in form and details may be made therein without departing from the spirit and scope of the described embodiments as defined in the appended claims. Accordingly, the breadth and scope of the present embodiments should not be limited by any of the above-described exemplary embodiments, but should be defined only in accordance with the following claims and their equivalents.

What is claimed is:

1. A method for determining similarities between two or more trademark portfolios, comprising:
receiving a user request that identifies a first entity;
determining a first trademark portfolio comprising trademarks owned by the first entity;
determining a first trademark portfolio profile for the first entity based on the first trademark portfolio;
calculating a first portfolio similarity score indicating the similarity between the first trademark portfolio profile and a second trademark portfolio profile corresponding to a second entity;
including, based on the first portfolio similarity score meeting a predetermined criterion, the second entity in a first set of output entities; and
providing the first set of output entities to the user.

2. The method of claim 1, wherein determining the first trademark portfolio profile comprises generating a first feature vector by extracting features related to a first trademark from the first trademark portfolio.

3. The method of claim 2, wherein calculating a first portfolio similarity score comprises:
providing the first feature vector as input to a portfolio similarity score calculator,
and
receiving as output from the portfolio similarity score calculator an identifier of the second entity and the first portfolio similarity score, the first portfolio similarity score indicating a similarity between the first feature vector and a second feature vector corresponding to the second entity.

4. The method of claim 2, wherein the first feature vector comprises features related to at least one of:
at least one of a trademark class or a trademark sub-class of each trademark in the first trademark portfolio,
a tally of trademarks owned by the first entity in the at least one of the trademark class and or trademark sub-class, or
a percentage of trademarks owned by the first entity in each of the at least one of the trademark classes or the trademark sub-classes out of a total number of trademarks in first trademark portfolio.

5. The method of claim 3, wherein the first feature vector comprises features related to at least one of:
at least one of a trademark class or a trademark sub-class of each trademark in the first trademark portfolio,
a tally of trademarks owned by the first entity in the at least one of the trademark class or the trademark sub-class, or
a percentage of trademarks owned by the first entity in each of the at least one of the trademark classes or the trademark sub-classes out of a total number of trademarks in first trademark portfolio.

6. The method of claim 1, further comprising:
receiving monitoring criteria from the user;
monitoring trends in a second portfolio similarity score indicating a similarity between the first trademark portfolio profile and a third trademark portfolio profile corresponding to a third entity; and
providing an alert to the user when the monitored trends in the second portfolio similarity score satisfy the monitoring criteria, the alert identifying the third entity.

7. The method of claim 6, wherein monitoring the trends in the second portfolio similarity score comprises:
updating a database of the trademarks by adding newly registered trademarks and to generate an updated database of trademarks;
recalculating the second portfolio similarity score between the first trademark portfolio profile and the third trademark portfolio profile; and
tracking changes in the second portfolio similarity score over time.

8. The method of claim 1, further comprising:
receiving filtering criteria from the user;
filtering, based on the filtering criteria, a plurality of additional entities to generate a set of filtered entities; and
providing the set of filtered entities to the user.

9. The method of claim 8, wherein the filtering criteria comprise at least one of:
a similarity score threshold;
a maximum number of filtered entities to be included in the set of filtered entities,
a geographical region of the filtered entities, or
a market sector of the filtered entities.

10. The method of claim 1, wherein the first trademark portfolio further comprises trademarks owned by subsidiaries of the first entity.

11. A system for determining similarities between two or more trademark portfolios, comprising:
a processor circuit; and
a memory that stores program code configured to be executed by the processor circuit, the program code configured to, when executed by the processor circuit, cause the system to perform a method comprising:
receiving a user request that identifies a first entity;
determining a first trademark portfolio comprising trademarks owned by the first entity;
determining a first trademark portfolio profile for the first entity based on the first trademark portfolio;
calculating a first portfolio similarity score indicating the similarity between the first trademark portfolio profile and a second trademark portfolio profile corresponding to a second entity;
including, based on the first portfolio similarity score, the second entity in a first set of output entities; and
providing the first set of output entities to the user.

12. The system of claim 11, wherein determining the first trademark portfolio profile comprises generating a first feature vector by extracting features related to a first trademark from the first trademark portfolio.

13. The system of claim 12, wherein calculating a first portfolio similarity score comprises:
providing the first feature vector as input to a portfolio similarity score calculator,
and
receiving as output from the portfolio similarity score calculator an identifier of the second entity and the first portfolio similarity score, the first portfolio similarity score indicating a similarity between the first feature vector and a second feature vector corresponding to the second entity.

14. The system of claim 12, wherein the first feature vector comprises features related to at least one of:
at least one of a trademark class or a trademark sub-class of each trademark in the first trademark portfolio,
a tally of trademarks owned by the first entity in the at least one of the trademark class or the trademark sub-class, or
a percentage of trademarks owned by the first entity in each of the at least one of the trademark classes or the trademark sub-classes out of a total number of trademarks in first trademark portfolio.

15. The system of claim 13, wherein the first feature vector comprises features related to at least one of:
at least one of a trademark class or a trademark sub-class of each trademark in the first trademark portfolio,
a tally of trademarks owned by the first entity in the at least one of the trademark class or the trademark sub-class, or
a percentage of trademarks owned by the first entity in each of the at least one of the trademark classes or the trademark sub-classes out of a total number of trademarks in first trademark portfolio.

16. The system of claim 11, wherein the method further comprises:
receiving monitoring criteria from the user;
monitoring trends in a second portfolio similarity score indicating a similarity between the first trademark portfolio profile and a third trademark portfolio profile corresponding to a third entity; and
providing an alert to the user when the monitored trends in the second portfolio similarity score satisfy the monitoring criteria, the alert identifying the third entity.

17. The system of claim 11, wherein monitoring the trends in the second portfolio similarity score comprises:
updating a database of the trademarks by adding newly registered trademarks and to generate an updated database of trademarks;
recalculating the second portfolio similarity score between the first trademark portfolio profile and the third trademark portfolio profile; and
tracking changes in the second portfolio similarity score over time.

18. The system of claim 11, wherein the method further comprises:
receiving filtering criteria from the user;
filtering, based on the filtering criteria, a plurality of additional entities to generate a set of filtered entities; and
providing the set of filtered entities to the user.

19. The system of claim 18, wherein the filtering criteria comprise at least one of:
a similarity score threshold;
a maximum number of filtered entities to be included in the set of filtered entities,
a geographical region of the filtered entities, or
a market sector of the filtered entities.

20. A computer-readable storage medium having program instructions recorded thereon that, when executed by at least one processor, perform a method for determining similarities between two or more trademark portfolios, the method comprising:
receiving a user request that identifies a first entity;
determining a first trademark portfolio comprising trademarks owned by the first entity;
determining a first trademark portfolio profile for the first entity based on the first trademark portfolio;
calculating a first portfolio similarity score indicating the similarity between the first trademark portfolio profile and a second trademark portfolio profile corresponding to a second entity;
including, based on the first portfolio similarity score, the second entity in a first set of output entities; and
providing the first set of output entities to the user.

21. The computer-readable storage medium of claim 20, wherein determining the first trademark portfolio profile comprises generating a first feature vector by extracting features related to a first trademark from the first trademark portfolio.

22. The computer-readable storage medium of claim 21, wherein calculating a first portfolio similarity score comprises:
providing the first feature vector as input to portfolio similarity score calculator,
and
receiving as output from the portfolio similarity score calculator an identifier of the second entity and the first portfolio similarity score, the first portfolio similarity score indicating a similarity between the first feature vector and a second feature vector corresponding to the second entity.

23. The computer-readable storage medium of claim 21, wherein the first feature vector comprises features related to at least one of:
at least one of a trademark class or a trademark sub-class of each trademark in the first trademark portfolio,
a tally of trademarks owned by the first entity in the at least one of the trademark class or the trademark sub-class, or
a percentage of trademarks owned by the first entity in each of the at least one of the trademark classes or the trademark sub-classes out of a total number of trademarks in first trademark portfolio.

24. The computer-readable storage medium of claim 22, wherein the first feature vector comprises features related to at least one of:
at least one of a trademark class or a trademark sub-class of each trademark in the first trademark portfolio,
a tally of trademarks owned by the first entity in the at least one of the trademark class or the trademark sub-class, or
a percentage of trademarks owned by the first entity in each of the at least one of the trademark classes or the trademark sub-classes out of a total number of trademarks in first trademark portfolio.

25. The computer-readable storage medium of claim 20, wherein the method further comprises:
receiving monitoring criteria from the user;
monitoring trends in a second portfolio similarity score indicating a similarity between the first trademark portfolio profile and a third trademark portfolio profile corresponding to a third entity; and
providing an alert to the user when the monitored trends in the second portfolio similarity score satisfy the monitoring criteria, the alert identifying the third entity.

26. The computer-readable storage medium of claim 25, wherein monitoring the trends in the second portfolio similarity score comprises:
updating a database of the trademarks by adding newly registered trademarks and to generate an updated database of trademarks;
recalculating the second portfolio similarity score between the first trademark portfolio profile and the third trademark portfolio profile, and
tracking changes in the second portfolio similarity score over time.

27. The computer-readable storage medium of claim 20, wherein the method further comprises:
receiving filtering criteria from the user;
filtering, based on the filtering criteria, a plurality of additional entities to generate a set of filtered entities; and
providing the set of filtered entities to the user.

28. The computer-readable storage medium of claim 27, wherein the filtering criteria comprise at least one of:
a similarity score threshold;
a maximum number of filtered entities to be included in the set of filtered entities,
a geographical region of the filtered entities, or
a market sector of the filtered entities.
